(19) United States
(12) Patent Application Publication
(10) Pub. No.: US 2014/0127596 A1
(43) Pub. Date: May 8, 2014

(54) LITHIUM-AIR BATTERY

(71) Applicants: Yang Kook Sun, Seoul (KR); Hun Gi Jung, Busan (KR)

(72) Inventors: Yang Kook Sun, Seoul (KR); Hun Gi Jung, Busan (KR)

(73) Assignee: IUCF-HYU(INDUSTRY-UNIVERSITY COOPERATION FOUNDATION HANYANG UNIVERSITY), Seoul (KR)

(21) Appl. No.: 14/129,096

(22) PCT Filed: Jun. 25, 2012
(86) PCT No.: PCT/KR2012/005004

§ 371 Date: Dec. 23, 2013

(30) Foreign Application Priority Data
Jun. 24, 2011 (KR) 10-2011-0062000
Jun. 25, 2012 (KR) 10-2012-0068046

(51) Int. Cl. H01M 12/08

(52) U.S. Cl. CPC H01M 12/08
USPC 429/406; 429/403; 429/405

(57) ABSTRACT

The present invention relates to a lithium-air battery, and more particularly, to a lithium-air battery which comprises a gas diffusion-type positive electrode formed in a portion thereof contacting air, and which employs a low-volatility electrolyte, thus exhibiting the effect of preventing volatilization of the electrolyte, thereby enabling the battery to be used over a long period of time without safety problems and without degradation of the charging/discharging characteristics of the battery, and the effect of air flowing into the battery being provided in a quicker and more uniform manner while passing through the gas diffusion-type positive electrode, thus improving the performance of the battery.

### FIELD OF THE INVENTION

The present invention relates to a lithium-air battery.

### BACKGROUND OF THE INVENTION

It was reported that a lithium-air battery using oxygen in the air as a positive electrode active material shows quite large discharge capacity because oxygen is always supplied from outside of the battery, and a large amount of lithium metal as a negative active material can be charged in the battery.

Fundamental structure of the lithium-air battery is shown in FIG. 1. As shown In FIG. 1, the lithium-air battery has structure comprising: a gas diffusion-type oxygen electrode using carbon as a positive electrode 10, lithium metal or lithium compound as a negative electrode 20, and an organic electrolyte 30 between the positive electrode 10 and the negative electrode 20.

In this lithium-air battery, the lithium metal (Li) of the negative electrode 20 Is dissolved in the organic electrolyte 30 to be lithium ion (Li⁺+e⁻), the lithium ion reaches to the positive electrode 10, and then the ion reacts with oxygen (O₂) in the air of the positive electrode, resulting in making lithium oxide (Li₂O) for conducting discharging. Further, charging is conducted by reducing the lithium oxide (Li₂O) produced as described above by applying high voltage between the two electrodes.

Charging: Li⁺+e⁻->Li 4OH⁻->O₂+2H₂O+4e⁻

Discharging: Li->Li⁺+e⁻O₂+2H₂O+4e⁻->4OH⁻

In the past, this air battery used organic solvent as an electrolyte, but there was a safety problem when using the battery for a long time because this organic solvent is volatile and mixed with water. Further, on the process supplying air to the positive electrode, the positive electrode is degraded by moisture, carbon dioxide and the like contained in the air, and the moisture, carbon dioxide and the like contained in the air is delivered to the negative electrode through the organic electrolyte and reacted with the lithium in the negative electrode, thereby degrading the negative electrode. As a result, there was a problem of reducing the charging/discharging characteristic of the air battery.

### SUMMARY OF THE INVENTION

In order to solve the above-mentioned problems, the present invention is objected to provide an air battery system, which can be safely operated for a long time by preventing degradation of a positive electrode and a negative electrode, resulting from preventing reduction of electrolyte or water permeation.

In order to solve the above aspects, the present invention provides a lithium-air battery, which comprises: a positive electrode containing an electron-conducting material; a separator; a lithium salt-dissolved organic electrolyte; and a negative electrode, which can occlude and release lithium.

In the present invention, the positive electrode may be a carbon cloth, a carbon paper or a carbon felt, which is coated with an electron-conducting material, or a selective oxygen permeable membrane. In the present invention, the positive electrode may contain a gas diffusion-type electrode, where electrochemical reaction of oxygen is conducted. For this, it does not used a separate collector, and it is possible to use a carbon cloth, a carbon paper or a carbon felt, which is coated with an electron-conducting material, or a selective oxygen permeable membrane. The selective oxygen permeable membrane may be a membrane, which can be used for manufacturing a gas diffusion layer of the conventional fuel battery.

The gas diffusion-type positive electrode of the present invention can be manufactured by a method mixing an electron-conducting material and a hinder and then coating the above mixture on a collector such as metal mesh, or making the mixture of the electron-conducting material and the binder in the form of slurry and then coating on the metal mesh and drying thereof. One side of the gas diffusion-type positive electrode manufactured by the said method is exposed to the air, and the other side contacts to an electrolyte.

Discharging reaction at the gas diffusion-type positive electrode by the present invention can be expressed as follows.

2Li⁺+O₂+2e⁻->Li₂O₂ (1)

or 2Li⁺+½O₂+2e⁻->Li₂O (2)

In the above formulas, the lithium ion Li⁺ moves from the negative electrode to the surface of the positive electrode through the electrolyte. Further, oxygen O₂ is accepted from the air into inside of the gas diffusion-type electrode. When the Li₂O₂ or Li₂O produced by the discharging reaction is separated on the positive electrode, and covers all reaction sites on the positive electrode, the discharging reaction is completed. Further, electrode reaction during charging is the counter reaction of the reaction formulas (1) and (2). Accordingly, the produced oxygen is released out of the battery, and the lithium ion is reinserted in the negative electrode though the electrolyte.

In the present invention, the electron-conducting material may be selected from the group consisting of: carbon materials consisting of carbon black, ketjen black, acetylene black, active carbon powder, carbon molecular sieve, carbon nanotube, carbon nanowire, activated carbon having micropores, mesoporous carbon and graphite; metal powder consisting of copper, silver, nickel and aluminum; and polyphenylene derivatives. The electron-conducting material in the gas diffusion-type electrode increases the reaction sites on the positive electrode, and it is preferred to have particle diameter of 40 nm or less and surface area of 1000 m²/g or more for enhancing dispersion rate of a catalyst.

In the present invention, the positive electrode may further comprise a metal collector. The collector may be aluminum (Al), nickel (Ni), iron (Fe), titanium (Ti), stainless and the like, but not limited thereto. The shape of the collector may be thin film-type, plate-type, mesh (or grid)-type, foam (or sponge)-type and the like, and it may be the foam (or sponge)-type having good collecting efficiency, preferably.

In the present invention, the metal collector may be coated with the electron-conducting material like on the positive electrode, preferably, for increasing the reaction sites on the positive electrode.

In the present invention, the organic electrolyte may be expressed by general formula of R¹(CR³₂CR⁴₂O)ₙR², wherein, n may be 2 to 10, R¹ and R2 may be each independently selected from H, alky, cycloalkyl, aryl, heterocyclyl, heteroaryl, alkoxy, silyl, substituted alkyl, substituted cycloalkyl, substituted aryl, substituted heterocyelyl, substituted heteroaryl, substituted alkoxy, substituted silyl and halogen.

In the present invention, the R³ and R⁴ may be each independently H, halogen, alkyl, cycloalkyl, aryl, substituted alkyl or substituted aryl.

In the present invention, the organic electrolyte may be polyethylene oxide, tetraethylene glycol diamine or dimethyl ether.

In the present invention, the lithium salt may be at least one selected from the group consisting of LiBF₄, LiClO₄, LiPF₆, LiAsF₆, LiCF₃SO₃, Li(CF₃SO₂)₂N, LiC₄F₉SO₃, Li(CF₃SO₂)₃C and LiBPh₄. The lithium salt may be used alone or in combination. The concentration of the lithium salt may be 0.1 to 2.0 M, preferably.

In the present invention, the positive electrode may further comprise a binder selected from the group consisting of PVDF, Kynar, polyethylene oxide, polyvinyl alcohol, Teflon, CMC and SBR. The binder plays roles of well adhering the positive electrode active material particles each other, and well adhering the positive electrode active materials on the collector. For example, it may be PVDF, Kynar, polyethylene oxide, polyvinyl alcohol, Teflon, CMC and SBR, but not limited thereto.

In the present invention, the positive electrode may further comprise a catalyst selected from the group consisting of Pt, Pd, Ru, Rh, Ir, Ag, An, Ti, V, Cr, Mn, Fe, Ni, Co, Cu, Mo, W, Zr, Zn, Ce and La metals, and oxides thereof. The catalyst is an oxidation-reduction catalyst of oxygen, and helps oxidation-reduction of oxygen by being mixed with the conducting material of the gas diffusion-type electrode and coated.

In the present invention, the separator may be a separator used in a general secondary battery, and it may be selected from a polyethylene or polypropylene polymer separator, or a glass fiber separator.

In the present invention, the negative electrode may be a lithium metal, a lithium metal composite treated with organic compounds or inorganic compounds, or a lithiated metal-carbon composite.

In the present invention, the metal of the lithiated metal-carbon composite may be selected from the group consisting of Mg, Ca, Al, Si, Ge, Sn, Pb, As, Bi, Ag, Au, Zn, Cd and Hg.

In the present invention, the lithiated metal-carbon composite may be a lithiated silicon-carbon composite or a lithiated tin-carbon. The lithiated metal-carbon composite electrode form a stable composite by being inserted in carbon crystal structure while lithium forms alloy with metal at the same time. Accordingly, metal volume is changed little during a charging/discharging process, and therefore, it has effects that the charging/discharging efficiency is improved without reduction of the cycle characteristic, the irreversible capacity during the initial charging/discharging can be controlled, and it can replace the lithium metal negative electrode with low stability.

In the present invention, the negative electrode may further comprise a binder selected from the group consisting of PVDF, Kynar, polyethylene oxide, polyvinyl alcohol, Teflon, CMC and SBR.

The shape of the lithium-air battery of the present invention is not particularly limited, but it may be, for example, coin-type, button-type, sheet-type, stacked-type, cylinder-type, plane-type, horn-type and the like. Further, it is also possible to be applied to large-size batteries for electric cars.

### ADVANTAGEOUS EFFECTS OF THE INVENTION

The air battery of the present invention uses a low-volatility electrolyte and contains a gas diffusion-type positive electrode formed in a portion thereof contacting air. Accordingly, the battery exhibits the effect of preventing volatilization of the electrolyte, thereby enabling the battery to be used over a long period of time without safety problems and without degradation of the charging/discharging characteristics of the battery, and the effect of air flowing into the battery being provided in a quicker and more uniform manner while passing through the gas diffusion-type positive electrode, thus improving the performance of the battery.

### BRIEF DESCRIPTION OF DRAWINGS

The above and other objects and features of the present invention will become apparent from the following description of the invention taken in conjunction with the following accompanying drawings, which respectively show:

FIG. 1: a diagram showing structure of a lithium-air battery;

FIGS. 2 to 8: results of measuring charging/discharging capacity of the lithium-air batteries, which are manufactured in Examples of the present invention with various conducting materials;

FIGS. 9 to 17: results of measuring charging/discharging capacity of the lithium-air batteries depending on charging/discharging temperature, which are manufactured in Examples of the present invention with various electrolytes;

FIGS. 18 to 20: results of measuring charging/discharging capacity of the lithium-air batteries, which are manufactured in Examples of the present invention with various binders;

FIGS. 21 and 22: the results of measuring charging/discharging capacity of the lithium-air batteries, which are manufactured by using a lithiated tin-carbon composite electrode and a lithiated silicon-carbon composite electrode as a negative electrode.

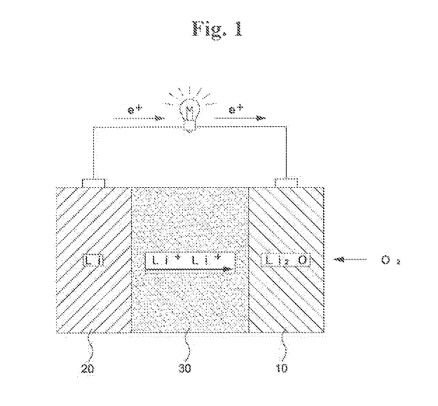

### DESCRIPTION OF SYMBOLS

10: Positive electrode

20: Negative electrode

30: Electrolyte

### DETAILED DESCRIPTION OF THE INVENTION

Hereinafter, Examples and Comparative Example will be described. The Examples are presented for illustrative purposes only, and do not limit the present invention.

### Example 1

TGP-H-30 carbon paper (Torray Industries Inc.) as a positive electrode was coated with each electron-conducting material of the following Table 1 as an electron-conducting material. The electron-conducting material 80 wt % was mixed with PVDF 20 wt % as a binder to prepare slurry, and coated on the TGP-H-30 carbon paper (Torray Industries Inc.) to the density of 1.0±0.1 mg carbon/cm², and then dried under vacuum at 100° C. for 12 hrs to remove residual solvent.

TABLE 1

| | Electron-conducting material |
|---|---|
| Example 1-1 | Super P |
| Example 1-2 | Vulcano carbon |
| Example 1-3 | CMK |
| Example 1-4 | CNT |
| Example 1-5 | Graphene oxide |
| Example 1-6 | Acetylene black |
| Example 1-7 | Ketjen black |

A 2032 coin-type cell was manufactured by using a gas diffusion layer (GDL) coated with the electron-conducting material prepared as described above as an air electrode, lithium metal as a negative electrode, (TEGDME)₄-LiCF₃SO₃, which was prepared by dissolving LiCF₃SO₃ salt in TEGDME (Aldrich) at molar ratio of 4:1, as an electrolyte and a separator (Celgard LLC, Celgard 3501) of porous polyethylene film.

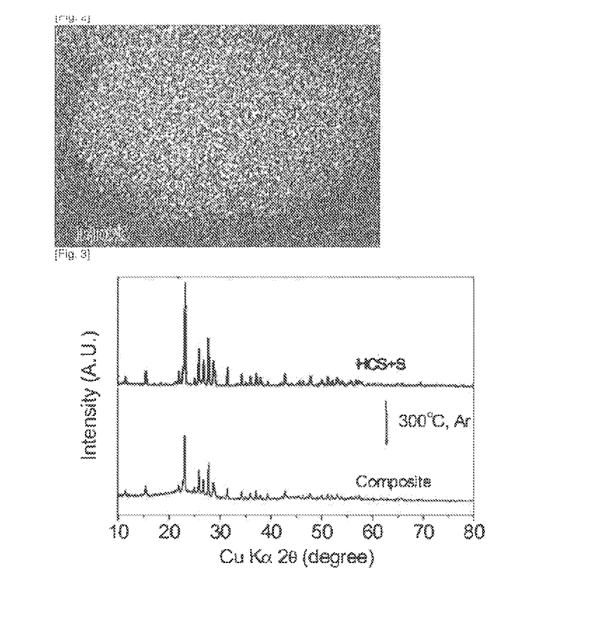

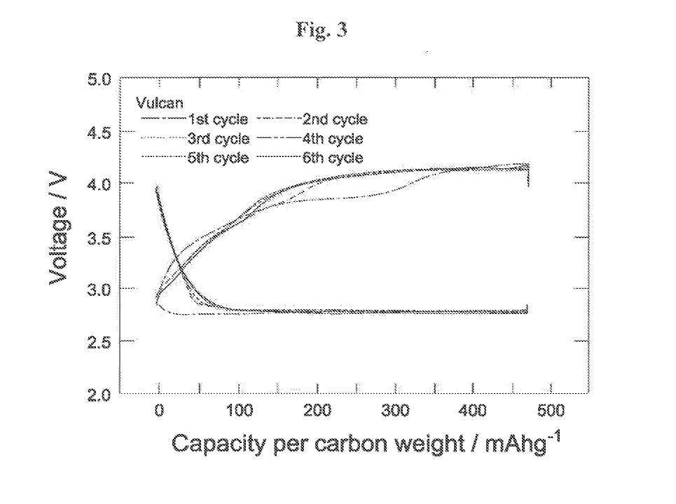

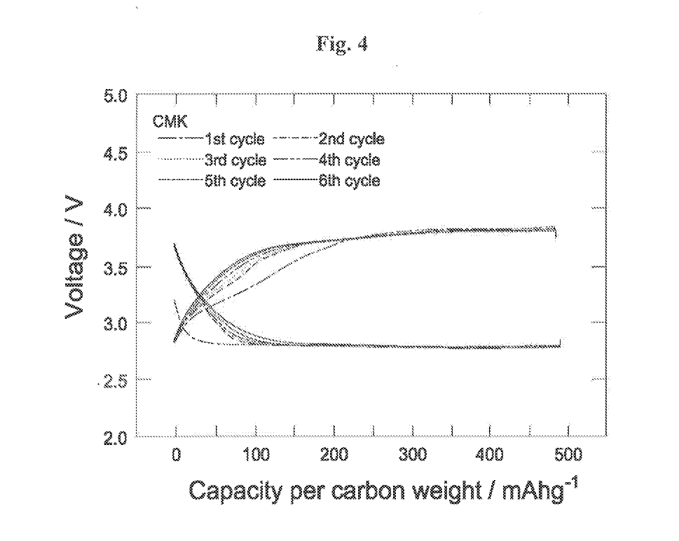

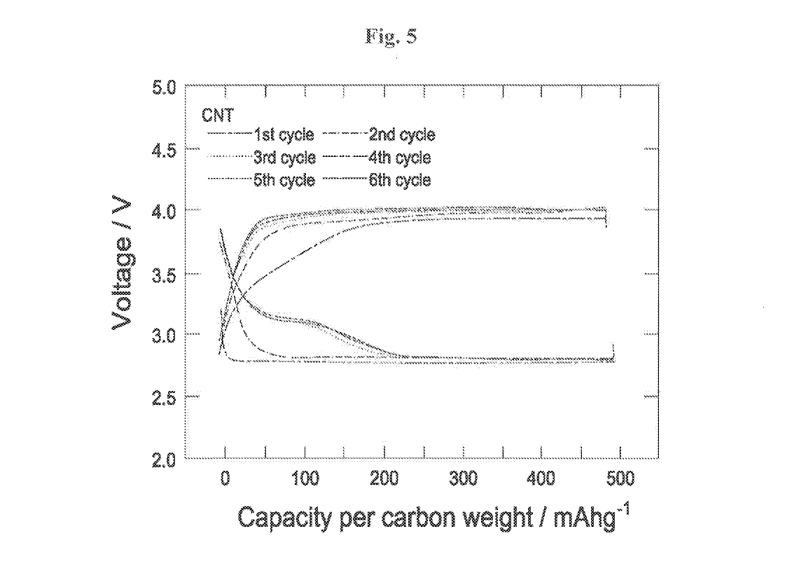

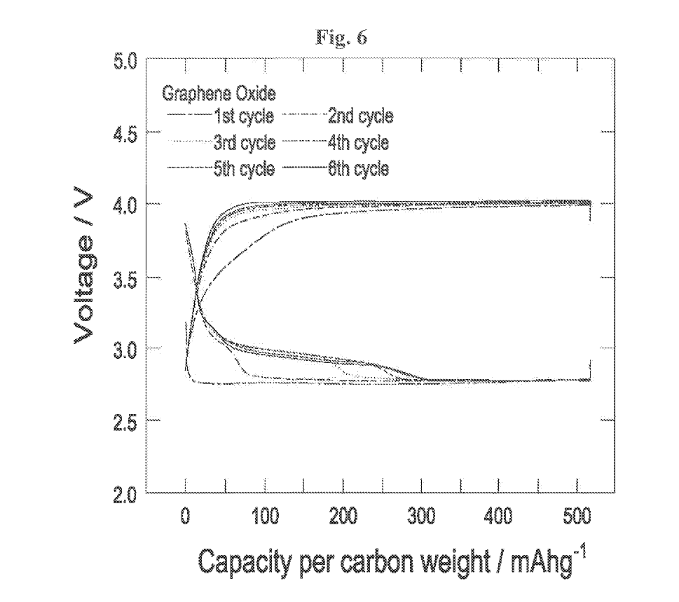

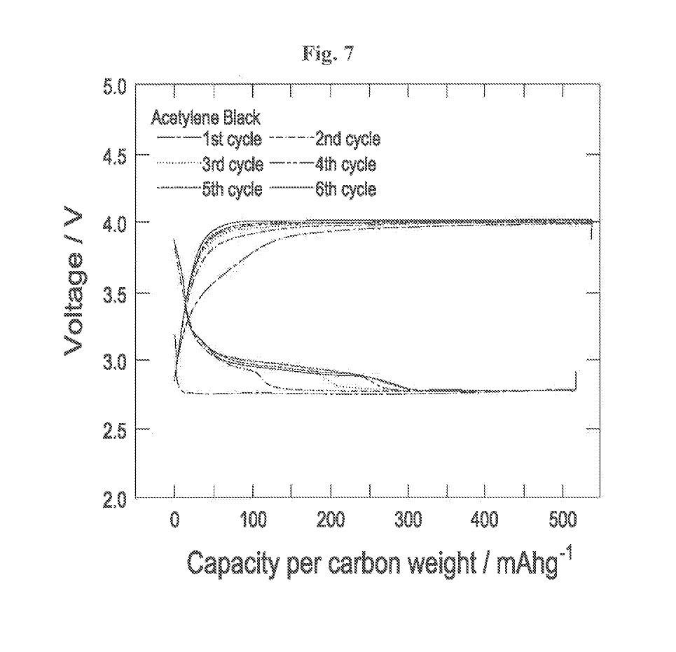

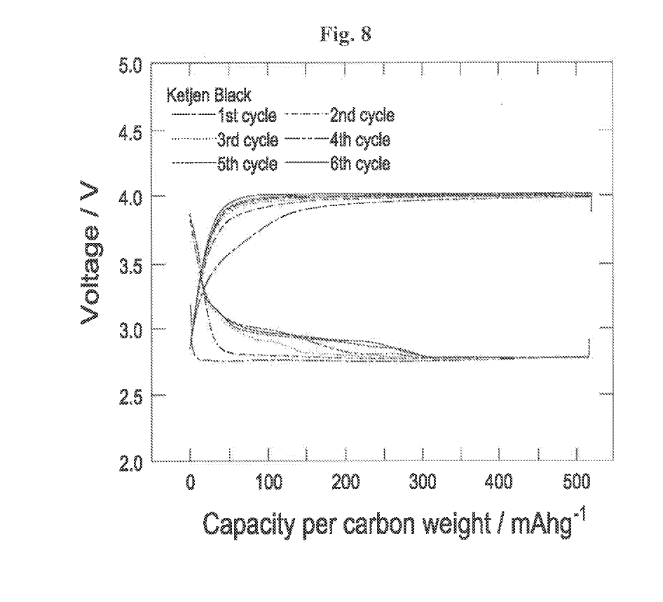

Charging/discharging capacity of the lithium-air batteries manufactured in Examples 1-1 to 1-7 was measured, and the results were shown in FIGS. 2 to 8.

As shown in FIGS. 2 to 8, the lithium-air batteries manufactured in Examples 1-1 to 1-7 showed the charging/discharging capacity of 500 mAh/g and the discharge voltage of around 2.7 V. Accordingly, it can be found that those can work enough as a battery.

### Example 2

TGP-H-30 carbon paper (Torray Industries Inc.) as a positive electrode was coated with Super P as an electron-conducting material with the same condition with Example 1.

A 2032 coin-type cell was manufactured by using a gas diffusion layer (GDL) coated with the electron-conducting material prepared as described above as an air electrode, lithium metal as a negative electrode, each electrolyte of the following Table 2 as an electrolyte and a separator (Celgard LLC, Celgard 3501) of porous polyethylene film.

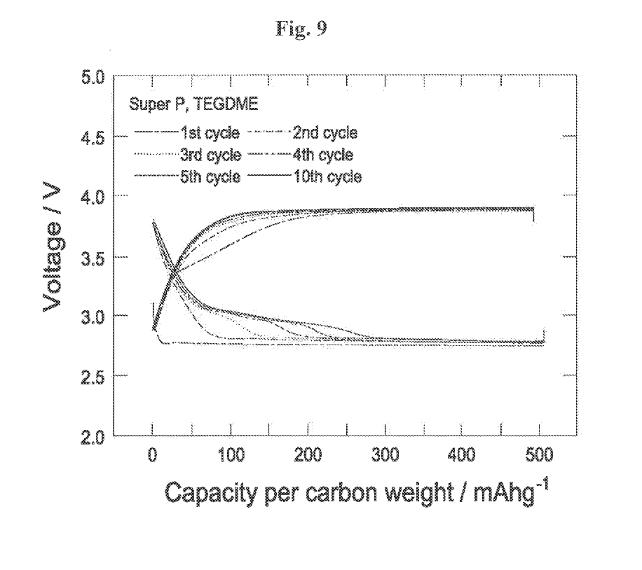

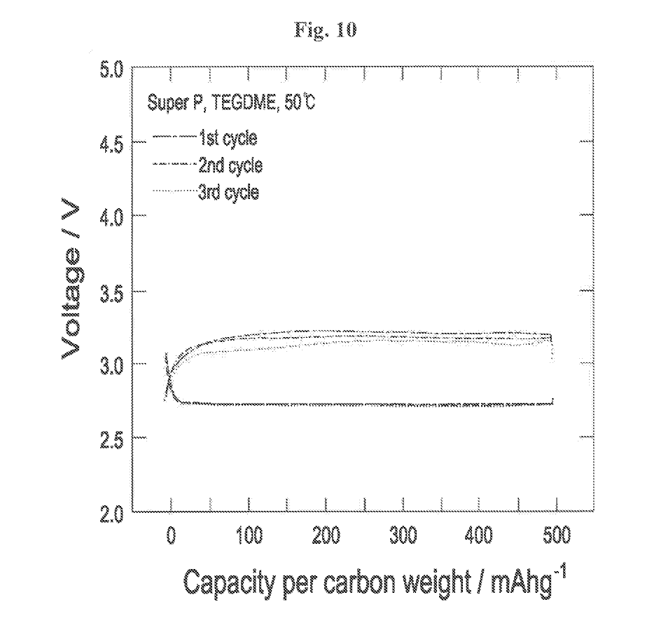

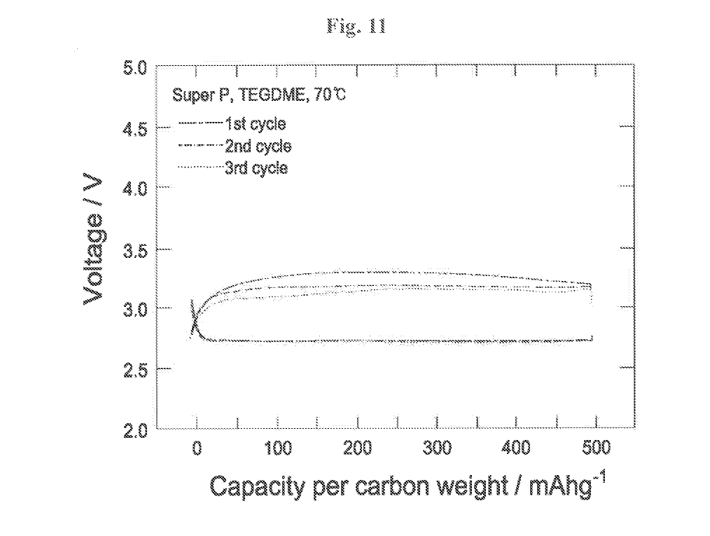

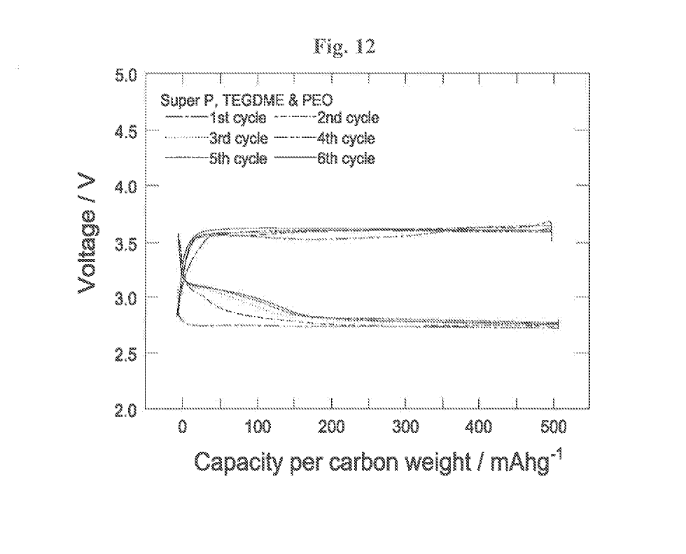

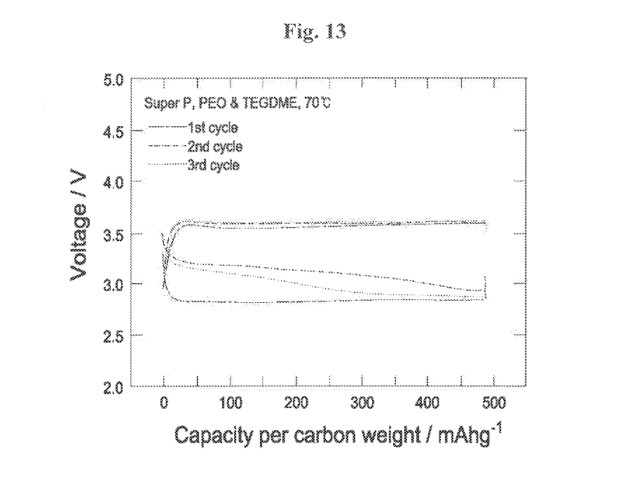

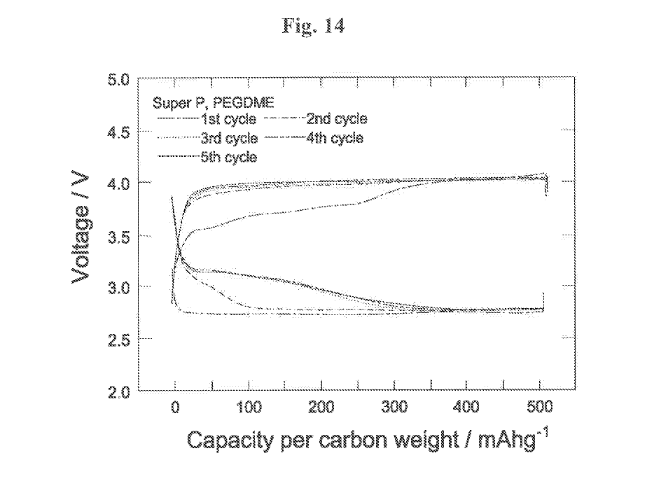

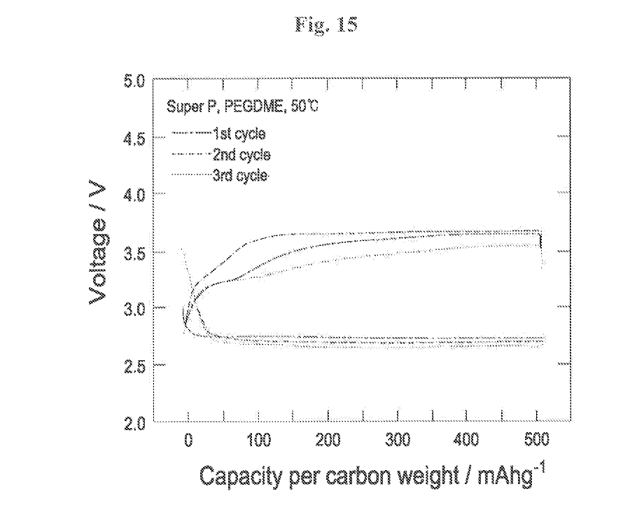

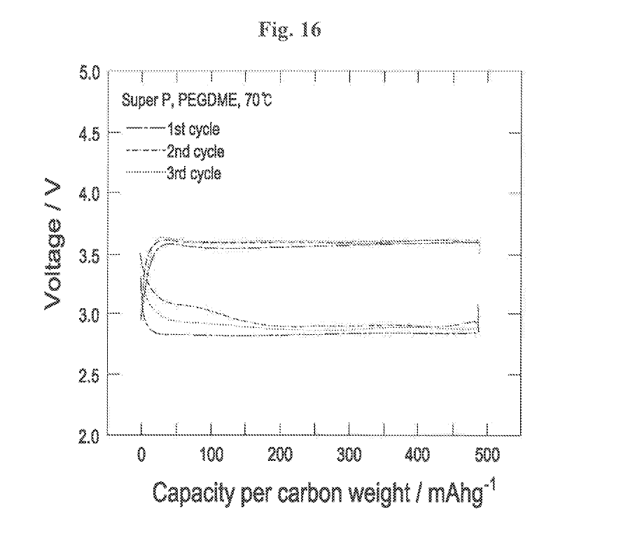

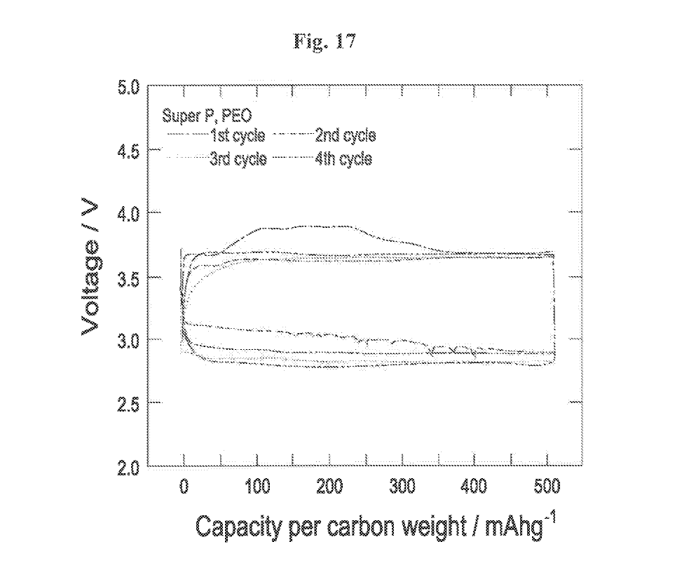

TABLE 2

| | | | Result of |
|---|---|---|---|
| | | | Measuring |
| | | | Charging/ |
| | | Discharge | Discharging |
| | Electrolyte Used | Temperature | Characteristics |
| Example | (TEGDME)₄-LiCF₃SO₃ | Room | FIG. 9 |
| 2-1 | | temperature | |
| | | 50° C. | FIG. 10 |
| | | 70° C. | FIG. 11 |
| Example | PEO-(TEGDME)₄-LiCF₃SO₃ | 50° C. | FIG. 12 |
| 2-2 | | 70° C. | FIG. 13 |
| Example | PEGDME-LiCF₃SO₃ | Room | FIG. 14 |
| 2-3 | | temperature | |
| | | 50° C. | FIG. 15 |
| | | 70° C. | FIG. 16 |
| Example | PEO-LiCF₃SO₃ | 70° C. | FIG. 17 |
| 2-4 | | | |

Charging/discharging capacity of the lithium-air batteries manufactured in Examples 2-1 to 2-4 was measured at the temperature of Table 2, and the results were shown in FIGS. 9 to 17.

As shown in FIGS. 9 to 17, when using as TEGDME an electrolyte, the charging voltage was 4.0 V and the discharging voltage was 2.7 V. Accordingly, it can be found that its charging/discharging capacity is the largest, and significantly reduced as the charging/discharging temperature increased from 50° C. to 70° C.

### Example 3

Positive electrodes and air batteries were manufactured as described in Example 1 by using TGP-H-30 carbon paper (Torray Industries Inc.) as a positive electrode and Super P as an electron-conducting material, and mixing the Super P 80 wt % with each binder of the following Table 3 20 wt %.

TABLE 3

| | Electrolyte Used |
|---|---|
| Example 3-1 | PVdF |
| Example 3-2 | PEO |
| Example 3-3 | Kynar |

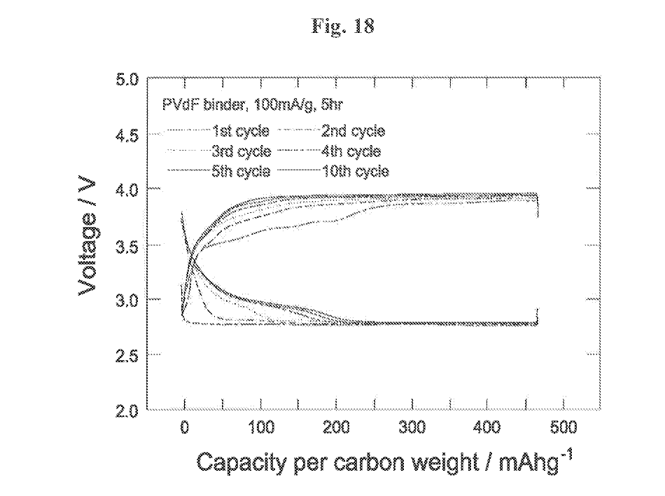

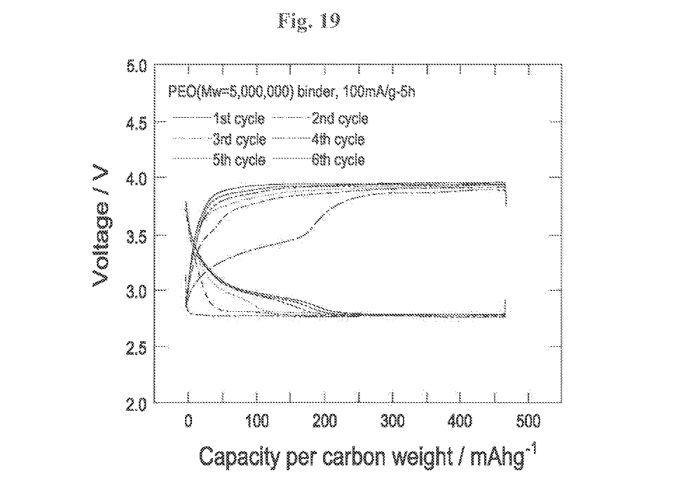

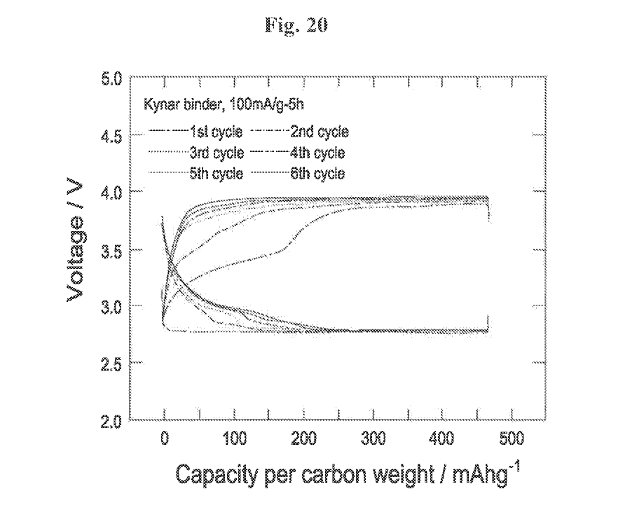

Charging/discharging capacity of the lithium-air batteries manufactured in Examples 3-1 to 3-3 was measured, and the results were shown in FIGS. 18 to 20.

As shown in FIGS. 18 to 20, it can be found that the charging voltage and the discharging voltage vary depending on types of binders, but similar each other.

### Example 4

A positive electrode was manufactured as described in Example 1 by coating TGP-H-30 carbon paper (Torray Industries Inc.) as a positive electrode with Super P as an electron-conducting material.

As a negative electrode, a lithiated tin-carbon composite electrode was Used. Resorcinol (Aldrich) 28 mmol and formaldehyde (37 wt % aqueous solution, Aldrich) 120 mmol were mixed, and sodium carbonate catalyst was added to the mixture at molar ratio of 45:100 to resorcinol. The obtained mixture was stirred at 75° C. for 1 hr to obtain a gel-type mixture. The obtained gel-type mixture was aged at room temperature for about 24 hrs. The aged mixture was washed with water and ethanol to remove sodium carbonate. The resulting product was soaked in tributylphenyl tin (Aldrich) solution (solvent; water, Concentration: 37 wt %) for a day, and then heated under Ar atmosphere at 700° C. for 2 clays to manufacture a tin-carbon composite. The manufactured tin-carbon composite. Super P carbon black conducting material and polyvinylene fluoride binder were mixed at the weight ratio of 80:10:10 in N-methylpyrrolidone solvent to manufacture tin-carbon composite slurry. The tin-carbon composite slurry was casted on Cu foil, and the obtained product was dried in an 100° C. oven for 2 hrs, and then vacuum dried for 12 hrs or more.

The vacuum dried product was cut into the proper size, lithium metal was set thereon, and then an electrolyte (1.2 M LiPF₆-dissolved mixture solvent of ethylene carbonate and dimethyl carbonate (3:7 volume ratio)) was evenly sprinkled on the lithium metal. Then, 0.5 kg/cm² pressure was applied on the obtained product, kept for 30 min, and then the lithium metal was carefully removed to manufacture a lithiated tin-carbon composite electrode.

A 2032 coin-type cell was manufactured by using the Super P-coated gas diffusion layer (GDL) as an air electrode, the tin-carbon composite electrode as a negative electrode, (TEGDME)₄-LiCF₃SO₃, which dissolving LiCF₃SO₃ salt in TEGDME (Aldrich) at the molar ratio of 4:1, as an electrolyte and a separator (Celgard LLC, Celgard 3501) of porous polyethylene film.

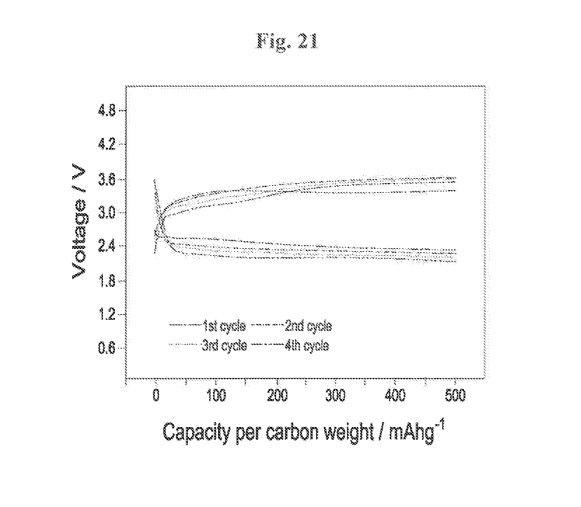

Charging/discharging capacity of the lithium-air battery manufactured as described above was measured, and the result was shown in FIG. 21.

As shown in FIG. 21, it can be found that lithium-air battery manufactured in Example 4 showed the charging/discharging capacity of 500 mAh/g and the discharge voltage of around 2.5 V. Accordingly, it can be found that it can work enough as a battery.

### Example 5

The procedure of Example 4 was repeated except for using a lithiated silicon-carbon composite electrode as a negative electrode to manufacture a lithium-air battery.

The lithiated silicon-carbon composite electrode was manufactured as follows. First of all, a silicon-graphite composite having particle size of 5 to 15 μm was prepared. The prepared silicon-graphite composite powder, Super P, CMC and SBR were mixed in NMF at the weight ratio of 85:5:3.3:6.7 to prepare slurry, and then casted on copper foil as a collector. The casted electrode was primarily dried in an 110° C. oven for 2 hrs, and then secondly dried under vacuum for 12 hrs to manufacture to the form of an electrode.

The manufactured electrode was cut into the size of 2×2 cm², Li metal was stacked on the electrode, a solution, wherein 12 M LiPF₆ was dissolved in EC:DMC mixed solution (3:7), was coated thereon, and then the pressure of 46 N/m² was applied on the stacked Li metal for 30 min to manufacture the lithiated silicon-carbon composite electrode.

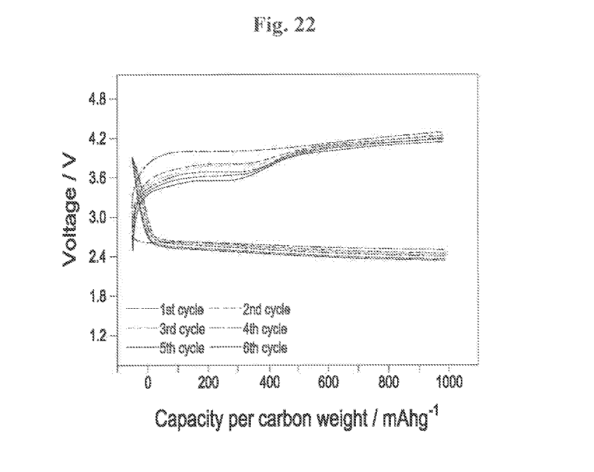

A 2032 coin-type cell was manufactured by using the lithiated tin-carbon composite electrode manufactured as described above as a negative electrode and (TEGDME)₄-LiCF₃SO₃ as an electrolyte, and then charging/discharging capacity of the manufactured lithium-air battery was measured, and the result was shown in FIG. 22.

### INDUSTRIAL APPLICABILITY

The air battery of the present invention uses a low-volatility electrolyte and contains a gas diffusion-type positive electrode formed in a portion thereof contacting air. Accordingly, the battery exhibits the effect of preventing volatilization of the electrolyte, thereby enabling the battery to be used over a long period of time without safety problems and without degradation of the charging/discharging characteristics of the battery, and the effect of air flowing into the battery being provided in a quicker and more uniform manner while passing through the gas diffusion-type positive electrode, thus improving the performance of the battery.

While the invention has been described with respect to the above specific embodiments, it should be recognized that various modifications and changes may be made and also fail within the scope of the invention as denned by the claims that follow.

1. A lithium-air battery comprising:
a positive electrode comprising an electron-conducting material;
a separator;
a lithium salt-dissolved organic electrolyte; and
a negative electrode, which can occlude or release lithium.

2. The lithium-air battery according to claim 1, wherein the positive electrode comprises a carbon cloth, a carbon paper or a carbon felt, which is coated with an electron-conducting material, or a selective oxygen permeable membrane.

3. The lithium-air battery according to claim 1, wherein the positive electrode further comprises a metal collector.

4. The lithium-air battery according to claim 3, wherein the metal collector is coated with an electron-conducting material.

5. The lithium-air battery according to claim 1, wherein the electron-conducting material is selected from the group consisting of: carbon materials consisting of carbon black, ketjen black, acetylene black, active carbon powder, carbon molecular sieve, carbon nanotube, carbon nanowire, activated carbon having micropores, mesoporous carbon and graphite; metal powder consisting of copper, silver, nickel and aluminum; and polyphenylene derivatives.

6. The lithium-air battery according to claim 1, wherein the organic electrolyte is expressed by General Formula R¹ (CR³₂CR⁴₂O)ₙR² (wherein, n is 2 to 10, R¹ and R² are each independently selected from H, alkyl, cycloalkyl, aryl, heterocyclyl, heteroaryl, alkoxy, silyl, substituted alkyl, substituted cycloalkyl, substituted aryl, substituted heterocyclyl, substituted heteroaryl, substituted alkoxy, substituted silyl and halogen).

7. The lithium-air battery according to claim 6, wherein the R³ and R⁴ are each independently H, halogen, alkyl, cycloalkyl, aryl, substituted alkyl or substituted aryl.

8. The lithium-air battery according to claim 6, wherein the organic electrolyte is polyethylene oxide, tetraethylene glycol diamine or dimethyl ether.

9. The lithium-air battery according to claim 1, wherein the lithium salt is at least one selected from the group consisting of LiBF₄, LiClO₄, LiPF₆, LiAsF₆, LiCF₃SO₃, Li(CF₃SO₂)₂N, LiC₄F₉SO₃, Li(CF₃SO₂)₃C and LiBPh₄.

10. The lithium-air battery according to claim 1, wherein the lithium salt is dissolved in an amount of 2 to 5 moles based on the organic electrolyte 1 mole.

11. The lithium-air battery according to claim 1, wherein the positive electrode further comprises a binder selected from the group consisting of PVDF, Kynar, polyethylene oxide, polyvinyl alcohol, Teflon, CMC and SBR.

12. The lithium-air battery according to claim 1, wherein the positive electrode further comprises a catalyst selected from the group consisting of Pt, Pd, Ru, Rh, Ir, Ag, Au, Ti, V, Cr, Mn, Fe, Ni, Co, Cu, Mo, W, Zr, Zn, Ce and La metals, and oxides thereof.

13. The lithium-air battery according to claim 1, wherein the separator is selected from the group consisting of a polyethylene separator, a polypropylene separator or a glass fiber separator.

14. The lithium-air battery according to claim 1, wherein the negative electrode is a lithium metal, a lithium metal composite treated with organic compounds or inorganic compounds, or a lithiated metal-carbon composite.

15. The lithium-air battery according to claim 14, wherein the metal of the lithiated metal-carbon composite is selected from the group consisting of Mg, Ca, Al, Si, Ge, Sn, Pb, As, Bi, Ag, Au, Zn, Cd and Hg.

16. The lithium-air battery according to claim 14, wherein the lithiated metal-carbon composite is a lithiated silicon-carbon composite or a lithiated tin-carbon composite.

17. The lithium-air battery according to claim 14, wherein the negative electrode further comprises a binder selected from the group consisting of PVDF, Kynar, polyethylene oxide, polyvinyl alcohol Teflon, CMC and SBR.
